(19) United States
(12) Patent Application Publication
(10) Pub. No.: US 2025/0055530 A1
(43) Pub. Date: Feb. 13, 2025

(54) METHODS, DEVICES, AND MEDIUM FOR COMMUNICATION

(71) Applicant: NEC CORPORATION, Tokyo (JP)

(72) Inventors: Yukai GAO, Beijing (CN); Peng GUAN, Beijing (CN); Gang WANG, Beijing (CN)

(73) Assignee: NEC CORPORATION, Tokyo (JP)

(21) Appl. No.: 18/719,088

(22) PCT Filed: Dec. 13, 2021
(86) PCT No.: PCT/CN2021/137608

§ 371 Date: Jun. 12, 2024

(51) Int. Cl. H04B 7/06; H04W 72/0446

(52) U.S. Cl. CPC H04B 7/0626; H04W 72/0446

(57) ABSTRACT

Example embodiments of the present disclosure relate to an effective mechanism for processing the CSI reports. In this solution, the terminal device determines a first priority value for a first channel state information (CSI) report at least in part based on an association relationship between the first CSI report and a set of capability parameters and further transmits the CSI report to a network device based on the determined priority value. In this way, a feasibly solution for calculating priority value is achieved, which may be satisfy requirements of different scenarios.

### FIELD

Example embodiments of the present disclosure generally relate to the field of communication techniques and in particular, to methods, devices, and medium for channel state information (CSI) configuring and reporting.

### BACKGROUND

In order to meet the increasing wireless data traffic demand, a plurality of schemes have been proposed and implemented, where the MIMO technology is considered as one powerful scheme to achieve high data throughputs in the communication system. MIMO includes features that facilitate utilization of a large number of antenna elements at a network device (such as, a base station, BS) for both sub-6 GHZ and over-6 GHz frequency bands.

Further, it is proposed that a terminal device (such as, a user equipment) may be deployed with more than one antenna element (also referred to as panel sometimes). In the 3rd-generation partnership project (3GPP) release 17 (Rel-17), it has been agreed to support reporting the panel-related information (such as, a panel-related CSI report). However, the details for configuring and reporting the panel-related CSI report are still needed to be further discussed.

### SUMMARY

In general, example embodiments of the present disclosure provide a solution for configuring and reporting. Embodiments that do not fall under the scope of the claims, if any, are to be interpreted as examples useful for understanding various embodiments of the disclosure.

In a first aspect, there is provided a method of communication. The method comprises: determining, at a terminal device, a first priority value for a first CSI report at least in part based on an association relationship between the first CSI report and a set of capability parameters; and transmitting, to a network device, the CSI report based on the determined priority value.

In a second aspect, there is provided a method of communication. The method comprises: generating, at a terminal device, a first and second CSI reports both of which are associated with a set of capability parameters; and processing the first and second CSI reports by at least one of the following: selecting a CSI report to carry identity information of a set of capability parameters from the first and second CSI reports; dropping one of the first and second CSI reports; or comprising a same identity information of a set of capability parameters in the first and second CSI reports.

In a third aspect, there is provided a method of communication. The method comprises: if a CSI report associated with a set of capability parameters is triggered, performing, at a terminal device, at least one of the following: applying a minimum processing time requirement specific to a CSI report associated with a set of capability parameters; or transmitting the CSI report regardless of at least of the following: whether a timeline requirement is satisfied; whether a processing time requirement is satisfied; whether a timing advance is satisfied, or whether a minimum processing time requirement is satisfied.

In a fourth aspect, there is provided a method of communication. The method comprises: receiving, at a terminal device and from a network device, a configuration indicating a repetition number for a CSI report associated with a set of capability parameters; and in response to a CSI report associated with a set of capability parameters being triggered, transmitting, based on the repetition number, the CSI report to the network device.

In a fifth aspect, there is provided a method of communication. The method comprises: generating, at a terminal device, at least one CSI report; and allocating a transmission power among the at least one CSI report based on at least one of the following: an association relationship between a CSI report and a set of capability parameters, or a time-domain behavior of a CSI report.

In a sixth aspect, there is provided a method of communication. The method comprises: generating, at a network device, a configuration indicating a repetition number for a CSI report associated with a set of capability parameters; and transmitting the configuration to a terminal device.

In an seventh aspect, there is provided a terminal device. The terminal device includes a processing unit; and a memory coupled to the processing unit and storing instructions thereon, the instructions, when executed by the processing unit, causing the device to perform the method according to the first aspect.

In an eighth aspect, there is provided a terminal device. The terminal device includes a processing unit; and a memory coupled to the processing unit and storing instructions thereon, the instructions, when executed by the processing unit, causing the device to perform the method according to the second aspect.

In a ninth aspect, there is provided a terminal device. The terminal device includes a processing unit; and a memory coupled to the processing unit and storing instructions thereon, the instructions, when executed by the processing unit, causing the device to perform the method according to the third aspect.

In a tenth aspect, there is provided a terminal device. The terminal device includes a processing unit; and a memory coupled to the processing unit and storing instructions thereon, the instructions, when executed by the processing unit, causing the device to perform the method according to the fourth aspect.

In an eleventh aspect, there is provided a terminal device. The terminal device includes a processing unit; and a memory coupled to the processing unit and storing instructions thereon, the instructions, when executed by the processing unit, causing the device to perform the method according to the fifth aspect.

In a twelfth aspect, there is provided a terminal device. The network device includes a processing unit; and a memory coupled to the processing unit and storing instructions thereon, the instructions, when executed by the processing unit, causing the device to perform the method according to the sixth aspect.

In a thirteenth aspect, there is provided a computer readable medium having instructions stored thereon, the instructions, when executed on at least one processor, causing the at least one processor to carry out the method according to any of the above first to sixth aspects.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some example embodiments of the present disclosure in the accompanying drawings, the above and other objects, features and advantages of the present disclosure will become more apparent, wherein:

FIG. 1 illustrates an example communication environment in which example embodiments of the present disclosure can be implemented;

FIG. 2 illustrates a signaling chart illustrating a process for communication according to some embodiments of the present disclosure;

FIG. 3 illustrates an example method performed by the terminal device according to some embodiments of the present disclosure;

FIG. 4 illustrates an example method performed by the terminal device according to some embodiments of the present disclosure;

FIG. 5 illustrates an example method performed by the terminal device according to some embodiments of the present disclosure;

FIG. 6 illustrates an example method performed by the terminal device according to some embodiments of the present disclosure;

FIG. 7 illustrates an example method performed by the network device according to some embodiments of the present disclosure;

FIG. 8 illustrates an example method performed by the network device according to some embodiments of the present disclosure; and

FIG. 9 illustrates a simplified block diagram of an apparatus that is suitable for implementing example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols, and/or any other protocols cither currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “terminal device” refers to any device having wireless or wired communication capabilities. Examples of the terminal device include, but not limited to, UE, personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also be incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

As used herein, the term “network device” refers to a device which is capable of providing or hosting a cell or coverage where terminal devices can communicate. Examples of a network device include, but not limited to, a satellite, a unmanned aerial systems (UAS) platform, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHZ-7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

In current wireless communication network, a terminal device may perform some measurements and transmit the measurement results (such as, a CSI report) to the network device. In the related solution, a network device may configure the terminal device to report the CSI report. In some embodiments, the terminal device may be configured with reporting configuration for CSI report. For example, the reporting configuration for CSI report may be at least one of aperiodic, periodic and semi-persistent. In some embodiments, the aperiodic CSI report may be transmitted on physical uplink shared channel (PUSCH). In some embodiments, the periodic CSI report may be transmitted on physical uplink control channel (PUCCH). In some embodiments, the semi-persistent CSI report may be transmitted on PUCCH or PUSCH activated by downlink control information (DCI) message.

In some embodiments, the terminal device may be configured to perform periodic CSI reporting by a higher layers signaling (for example, by an RRC signaling). Alternatively, in some embodiments the terminal device may be semi-statically configured by the RRC signaling. For example, the terminal device may be configured to perform semi-persistent CSI report by a higher layers signaling (for example, by an RRC signaling). For example, the terminal device may perform semi-persistent CSI reporting (for example, on PUCCH) starting from the first slot that is after slot may be configured n+3Nₛₗₒₜ^{subframe,μ} when the terminal device would transmit a PUCCH with HARQ-ACK information in slot n corresponding to the PDSCH carrying the activation command, where u is the subcarrier spacing (SCS) configuration for the PUCCH. In some embodiments, the value of μ may be one of {0,1,2,3,4,5,6,7,8}. In some embodiments, the value of Nₛₗₒₜ^{subframe,μ} may be one slot of {1, 2, 4, 8, 16, 32, 64, 128, 256}.

Some example values of μ and Nₛₗₒₜ^{subframe,μ} are illustrated as below:
In case that the value of μ is 0, the value of Nₛₗₒₜ^{subframe,μ} may be 1.
In case that the value of μ is 1, the value of Nₛₗₒₜ^{subframe,μ} may be 2.
In case that the value of μ is 2, the value of Nₛₗₒₜ^{subframe,μ} may be 4.
In case that the value of μ is 3, the value of Nₛₗₒₜ^{subframe,μ} may be 8.
In case that the value of μ is 4, the value of Nₛₗₒₜ^{subframe,μ} may be 16.
In case that the value of μ is 5, the value of Nₛₗₒₜ^{subframe,μ} may be 32.
In case that the value of μ is 6, the value of Nₛₗₒₜ^{subframe,μ} may be 64.
In case that the value of μ is 7, the value of Nₛₗₒₜ^{subframe,μ} may be 128.
In case that the value of μ is 8, the value of Nₛₗₒₜ^{subframe,μ} may be 256.

It is to be understood that the above values are only for the purpose of illustration without suggesting any limitations. In some other example embodiments, parametersμ and Nₛₗₒₜ^{subframe,μ} may be configured with other values.

In some embodiments, the terminal device may perform semi-persistent CSI report on the PUSCH upon successful decoding of a DCI message (For example, DCI format 0_1 or DCI format 0_2) which activates a semi-persistent CSI trigger state. Specifically, an information element (IE) CSI-ReportConfig may be used to configure a periodic or semi-persistent CSI reporting for the terminal device.

Below is an example of part of the IE CSI-ReportConfig.

| | |
|---|---|
| reportQuantity | CHOICE { |
| none | NULL, |
| cri-RI-PMI-CQI | NULL, |
| cri-RI-i1 | NULL, |
| cri-RI-i1-CQI | SEQUENCE { |
| pdsch-BundleSizeForCSI | ENUMERATED {n2, n4} OPTIONAL -- Need S |

},

| | |
|---|---|
| cri-RI-CQI | NULL, |
| cri-RSRP | NULL, |
| ssb-Index-RSRP | NULL, |
| cri-RI-LI-PMI-CQI | NULL |

},

Further, the network device also may transmit a message to trigger an aperiodic CSI report. Accordingly, the terminal device may generate and transmit the CSI report to the network device.

Further, there may be a plurality of CSI reports needed to be transmitted to the network device. In the related solutions, the terminal device may determine a priority for each CSI report, which ensures that the CSI carrying important information may be in time. In one specific example embodiments, a priority value of a CSI report (be represented as Pri_{iCSI}) may be calculated as below Equation (1).

$${Pri}_{iCSI} ( y , k , c , s ) = 2 \cdot {N}_{cells} \cdot {M}_{s} \cdot y + {N}_{cells} \cdot {M}_{s} \cdot k + {M}_{s} \cdot c + s \qquad ( 1 )$$

where
y=0 for aperiodic CSI reports to be carried on PUSCH y=1 for semi-persistent CSI reports to be carried on PUSCH, y=2 for semi-persistent CSI reports to be carried on PUCCH and y=3 for periodic CSI reports to be carried on PUCCH;
k=0 for CSI reports carrying L1-RSRP or L1-SINR and k=1 for CSI reports not carrying L1-RSRP or L1-SINR;
c is the serving cell index and N_{cells} is the value of the higher layer parameter maxNrofServingCells;
s is the reportConfigID and Mₛ is the value of the higher layer parameter maxNrofCSI-ReportConfigurations.

In some embodiments, a CSI report (for example, represented as CSI report A) may be said to have priority over another CSI report (for example, represented as CSI report B), if the associated priority value (for example Pri_{iCSI}) for CSI report A is smaller than that for CSI report B.

In some embodiments, two CSI reports may be said to being colliding if the time occupancy of the physical channels scheduled to carry the two CSI reports overlaps in at least one orthogonal frequency division multiplexing (OFDM) symbol while the two CSI reports are transmitted on a same carrier.

In some embodiments, when the terminal device is configured to transmit two colliding CSI reports, the CSI report with a bigger priority value (i. e., Pri_{iCSI}) (corresponding to a lower priority level) may not be sent by the terminal device. In one specific example embodiments, in case that the y values are different between the two CSI reports, when the terminal device is configured to transmit two colliding CSI reports, the two colliding CSI reports may be multiplexed or either or both of the two CSI reports may be dropped based on the priority values.

Alternatively, in another specific example, the y values are same between the two CSI reports. In some embodiments, when the two CSI reports are multiplexed, the order of multiplexing of the two CSI reports may be based on the ascending or descending order of the priority values of the two CSI reports. Alternatively, in some other embodiments, either or both of the two CSI reports may be dropped based on a code rate.

In some embodiments, if the code rate is equal to or larger than a maximum code rate, the CSI report with higher priority value may be dropped. For example, after dropping the CSI report with higher priority value, the code rate of remaining CSI reports is equal to or smaller than the maximum code rate.

Alternatively, in some embodiments, if the code rate is equal to or larger than a maximum code rate, both of the two CSI reports may be dropped. For example, after dropping the CSI report with higher priority value, the code rate of remaining CSI reports is still equal to or larger than the maximum code rate.

In some embodiments, the maximum code rate may be configured by the network device. For example, the value of the maximum code rate may be one of {0.08, 0.15, 0.25, 0.35, 0.45, 0.60, 0.80}.

With the CSI report(s) transmitted by the terminal device, the network device may obtain the channel quality and perform beam management, resource allocation and so on.

As discussed above, it is proposed that a terminal device may be deployed with more than one antenna element/panel. Generally speaking, the terminal device selects and uses one antenna element/panel to communicate with the network device. However, the communication environment/condition may change over time, such as due to moving and so on. Therefore, there is a need that the terminal device may switch to another panel to communicate with the network device. If so, the terminal device needs to transmit panel-related information to the network device (such as, a CSI report specific to the panel expected to be switch to). Of course, there are other scenarios (such as, due to maximum permissible exposure, MPE) where a terminal device needs to transmit the panel-related information to the network device. For brevity, other example scenarios are not illustrated herein.

In order to satisfy the requirements from the above discussed scenarios, an enhancement on multi-beam operation has been raised. Specifically, it is expected to facilitate uplink (UL) beam selection for the terminal device equipped with multiple panels based on an UL beam indication with the unified transmission configuration indicator (TCI) framework for UL fast panel selection.

In the 3GPP Rel-17, it has been agreed to support reporting the panel-related information (such as, a panel-related CSI report). However, therefore are still pending issues needed to be further discussed and stipulated.

One pending issue is how to exchange capability-related information and related configuration to enable an efficient reporting for the panel-related CSI report. Another pending issue is how to handle the priority relationship between the panel-related CSI report and the other CSI reports. A further pending issue is how to improve the reliability of the panel-related CSI report. Other pending issues, include but are not limited to, how to allocate the transmission power for the panel-related CSI report, how to apply/define a (minimum) processing time requirement, a timeline requirement, a timing advance requirement and so on.

According to some of the embodiments, at least part of the above illustrated pending issued will be addressed. It should be understood that the above illustrated issues are only for the purpose of illustration without suggesting any limitations. Both of the pending issues and the issues addressed by the present disclosure also are not limited to the above illustrated issues.

In the following, a layer 1-reference signal received power (L1-RSRP)/L1-signal to interference and noise ratio (L1-SINR) will be used as an example of signal measurement result for describing some specific example embodiments of the present disclosure. It is to be understood that example embodiments described with regard to the L1-RSRP/L1-SINR may be equally applicable to other type of signal measurement result, including but not limited to L3-RSRP, L3-SINR, L1/L3 received signal strength indicator (RSSI), L1/L3 reference signal received quality (RSRQ), and so on. The present disclosure is not limited in this regard.

Generally speaking, one panel discussed herein refers to one or more antenna elements deployed at a certain area of a terminal device. In this regard, the terms (and their equivalent expressions) “panel”, “panel type”, “antenna element(s)”, “antenna array(s)”, “transmission reception point(s)”, “TRPs” can be used interchangeably.

Further, one panel may correspond to a set of capability parameters (also referred to as “UE capability value set” sometimes). Further, a panel/a set of capability parameters may have an identity (such as, an index). In some embodiment, a CSI report may carry the identity of the set of capability parameters. In this regard, the terms (and their equivalent expressions) “a panel-related CSI report”, “a CSI report including/comprising/carrying/with panel-related information”, “a CSI report including/comprising/carrying/with an identity/index of a panel”, “a CSI report including/comprising/carrying/with an index of a set of capability parameters”, “a CSI report including/comprising/carrying/with an identity/index of a UE capability value set”, “a CSI report associated with a panel”, “a CSI report associated with a set of capability parameters” and “a CSI report associated with a UE capability value set” can be used interchangeably.

The terms “set of capability parameters”, “capability value set”, “panel index”, “panel type index”, “set of transmission configuration parameters” and “set of reception configuration parameters” can be used interchangeably.

In some embodiments, the CSI report carrying the identity information of the set of capability parameters may be configured with wideband frequency granularity. Alternatively, in some other embodiments, the CSI report carrying the identity information of the set of capability parameters may be configured to be per band, per band combination, per component carrier (CC), or per CC combination.

Correspondingly, the other CSI reports may be referred to any of the following: “a panel-irrelevant CSI report”, “a CSI report without panel-related information”, “a CSI report without an identity/index of a panel”, “a CSI report without an index of a set of capability parameters”, “a CSI report without an identity/index of a UE capability value set”, “a CSI report not associated with a panel”, “a CSI report not associated with a set of capability parameters” and “a CSI report not associated with a UE capability value set”, and the likes.

In addition, in the present discourse, the terms (and their equivalent expressions) “component carrier (CC) identity/index”, “cell identity/index” and “serving cell identity/index” can be used interchangeably.

In some embodiments, the terms “beam”, “set of QCL parameters”, “TCI state”, “QCL type”, “spatial reception parameter”, “spatial receiving parameter” and “spatial relation info” may be used interchangeably.

For ease of discussion, some parameters used in the following description are listed as below:
Pri_{CSI}: refers to a priority of a CSI;
y: a parameter associated with a time-domain behavior of a CSI and/or a channel type for transmitting the CSI report (such as, PUCCH, PPUSCH, and so on);
k: a parameter associated with whether a signal measurement result is carried in the CSI report;
c: the (serving) cell index;
N_{cells}: a value of the higher layer parameter maxNrofServingCells;
s: a value of the reportConfigID;
Mₛ: a value of the higher layer parameter maxNrofCSI-ReportConfigurations;
Cn: an index of a set of capability parameters or an index of a panel or the first index;
b: an identity of a frequency band correspond to a CSI, such as, an index of a frequency band;
B: a maximum number of the frequency bands;
L: a number of sets of capability-related parameters supported by the terminal device; also referred to as a first number; L is positive integer. In some embodiments, 1<=L<=8;
W: a number smaller than the first number L; corresponding to a number of subset of the sets of capability-related parameters supported by the terminal device; aslo referred to as a second number; the second number determined either by the terminal or the network device.

In some example embodiments, at least one of the above-listed parameters may be applied.

### EXAMPLE ENVIRONMENT

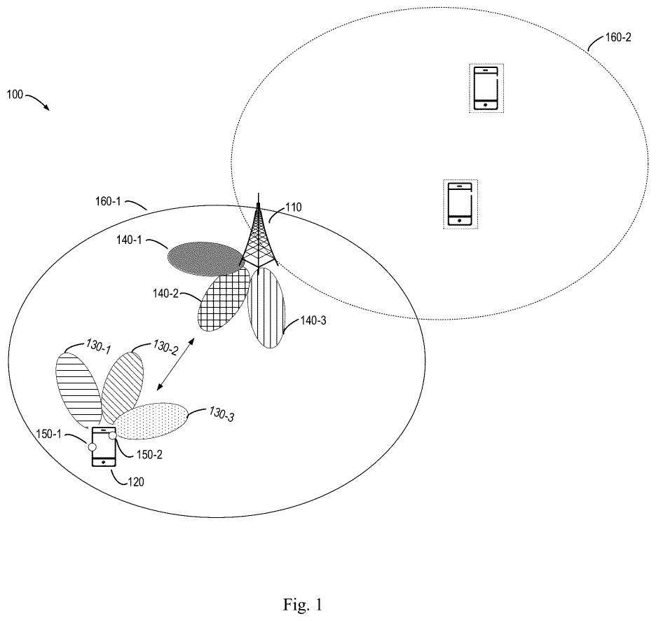

FIG. 1 shows an example communication environment 100 in which example embodiments of the present disclosure can be implemented.

The communication environment 100 includes a network device 110 and a terminal device 120, and further the network device 110 can communicate with the terminal device 120 via physical communication channels or links. Additionally, the network devices 110 may provide more than one serving area. In the specific example of FIG. 1, the network device 110 provides (serving) cells 160-1 and 160-2. In the following text, the cells 160-1 and 160-2 are collectively or individually referred to as cell 160.

In the specific example of communication environment 100, a link from the terminal device 120 to the network device 110 is referred to as UL, while a link from the network device 110 to the terminal device 120 is referred to as a downlink (DL). Further, the MIMO is supported in the communication environment, such that the network device 110 and the terminal device 120 may communicate with each other via different beams to enable a directional communication. In DL, the network device 110 is a transmitting (TX) device (or a transmitter) and the terminal device 120 is a receiving (RX) device (or a receiver), and the network device 110 may transmit DL transmission to the terminal device 120 via one or more beams. As illustrated in FIG. 1, the network device 110 transmits DL transmission to the terminal device 110 via the beams 140-1 to 140-3.

Correspondingly, in UL, the network device 110 is a RX device (or a receiver) and the terminal device 120 is a TX device (or a transmitter), and the terminal device 120 may transmit UL transmission to the network device 110 via one or more beams. As illustrated in FIG. 1, the terminal device 120 transmits UL transmission to the network device 110 via the beams 130-1 to 130-3. For purpose of discussion, the beams 130-1 to 130-3 or beams 140-1 to 140-3 are collectively or individually referred to as beam 130 or beam 140, respectively.

The network device 110 (such as, a gNB) may be equipped with one or more TRPs or antenna panels. As used herein, the term “TRP” refers to an antenna array (with one or more antenna elements) available to the network device 110 located at a specific geographical location. For example, a network device 110 may be coupled with one or more TRPs in different geographical locations to achieve better coverage. The one or more TRPs may be included in a same serving cell or different serving cells.

It is to be understood that the TRP can also be a panel(s), and the panel(s) can also refer to an antenna array (with one or more antenna elements). Although some embodiments of the present disclosure are described with reference to multiple TRPs for example, these embodiments are only for the purpose of illustration and help those skilled in the art to understand and implement the present disclosure, without suggesting any limitations as to the scope of the present disclosure. It is to be understood that the present disclosure described herein can be implemented in various manners other than the ones described below.

In some embodiments, one or more RS (such as, synchronization signal block, synchronization signal/physical broadcast channel (SS/PBCH) block, sounding reference signal, SRS, CSI-RS, and so on) may be associated with one beam. The terminal device 120 may measure on the beams/RSs and transmit the measurement result to the network device 110 via such as a CSI report.

In addition, the terminal device 120 may be deployed with more than one panel. As illustrated in FIG. 1, the terminal device 120 is deployed with panels 150-1 and 150-2. In the following, the panels 150-1 and 150-2 may be referred to as the first panel 150-1 and the second panel 150-2, respectively. In some embodiments, panels 150-1 and 150-2 may correspond to different sets of capability parameters, respectively.

In some embodiments, different panels correspond to different panel types/capability values. For example, the panels 150-1 and 150-2 may correspond to different number of SRS ports, frequency resource (frequency band, CC, beam and so on) and any other suitable capability parameters.

Further, in the specific example of FIG. 1, the network device 110 and the terminal device 120 may exchange capability-related information and relayed configuration, and the terminal device 120 may report CSI report(s) to the network device 110.

Additionally, in the specific example of FIG. 1, the panel-related CSI report is supported. Specifically, the terminal device 120 may perform a UE-initiated panel activation and selection via reporting a list of sets of capability parameters (i.e., UE capability value sets). Further, the correspondence between each reported CSI-RS and/or SSB resource index and one of the set of capability parameters in the reported list is determined by the terminal device 120 and is informed to network device 110 in a beam reporting instance.

In some embodiments, the index of corresponding set of capability parameters is reported along with the pair of SSB resource indicator (RI)/CSI-RS resource indicator (CRI) and L1-RSRP/SINR (up to 4 pairs, with 7-bit absolute and 4-bit differential) in an uplink control information for beam reporting.

Additionally, the terminal device 120 may report one index for all the reported CRIs/SSB RIs in one beam reporting. Alternatively, the terminal device 120 may report one index for each reported CRI/SSB RI in one beam reporting.

In some embodiments, a DL-only panel-related CSI report is supported which will be discussed in the following text.

In some embodiments, the supported panel-related CSI report may be configured with any suitable time domain behavior. One example of the time domain behavior is periodic. Another example of the time domain behavior is semi-persistent. A further example of the time domain behavior is aperiodic.

Additionally, in some embodiments, the supported panel-related CSI report is preferably configured with either of a periodic time domain behavior and a semi-persistent time domain behavior.

Additionally, in some embodiments, the triggering of the semi-persistent time domain behavior and the periodic time domain behavior is conditionally. In some embodiment, the semi-persistent time domain behavior and/or the periodic time domain behavior is triggered/allowed only when the periodic time domain behavior is configured.

The communications in the communication environment 100 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols.

It is to be understood that the numbers and their interrelationship of network device, terminal device, panel and cell are only for the purpose of illustration without suggesting any limitations. The communication environment 100 may include any suitable network device, terminal device, panel and cell adapted for implementing embodiments of the present disclosure. Further, it is to be understood that one or more additional terminal devices may be located in the respective cells.

It would also be appreciated that in some examples, only the homogeneous network deployment or only the heterogeneous network deployment may be included in the communication environment 100.

### EXAMPLE PROCESSES

It should be understood that although feature(s)/operation(s) are discussed in specific example embodiments separately, unless clearly indicated to the contrary, these feature(s)/operation(s) described in different example embodiments may be used in any suitable combination.

In addition, in the following description, some interactions are performed among the terminal device 120 and the network device 110 (such as, exchanging capability-related information, configuration and so on). It is to be understood that the interactions may be implemented either in one single signaling/message or multiple signaling/messages, including system information, RRC message, DCI message, uplink control information (UCI) message, media access control (MAC) control element (CE) and so on. The present disclosure is not limited in this regard.

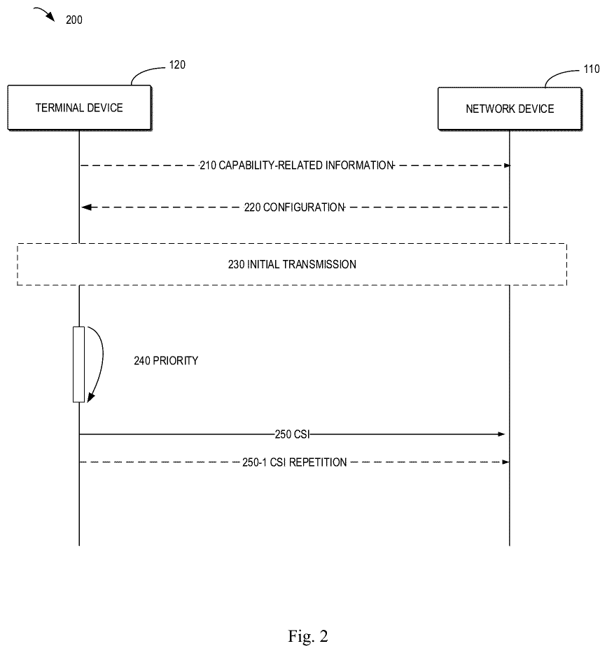

Principle and implementations of the present disclosure will be described in detail below with reference to FIG. 2, which shows a signaling chart illustrating a process 200 of communication according to some example embodiments of the present disclosure. For the purpose of discussion, the process 200 will be described with reference to FIG. 1. The process 200 may involve the terminal device 120 and the network device 110.

Further, the terminal device 120 may be deployed with more than one panel (such as, panel 150-1 and panel 150-2) and each panel corresponds to a set of capability parameters. Both of the panels and the set of capability parameters may be indexed according to an ascending or descending order.

### Example Processes for Exchanging Capability-Related Information

Optionally, the terminal device 120 and the network device 110 may communicate capability-related information and related configuration to enable the related features according to the present disclosure, which will be discussed as below. During this interactive procedure, certain rules for configuring and reporting the CSI report may be stipulated, and the related re-defined/newly-introduced parameters may be exchanged between the terminal device 120 and the network device 110. Additionally, the network device 110 may enable or disable the related features according to the present disclosure.

As illustrated in FIG. 2, the terminal device 120 transmits 210 capability-related information to the network device 110. Alternatively, on in addition, the network device 120 transmits 220 a related configuration to the terminal device 120.

In addition, the capability-related information and the related configuration may be carried in any suitable signalling/message(s), including but not limited to RRC message, DCI message, MAC CE and so on.

In this way, the existing signaling structure may be reused and updated to accommodate to the reporting of CSI report associated with a set of capability parameters.

One example of the capability-related information is whether the terminal device 120 supports to report the CSI report associated with a set of capability parameters.

In another example embodiment, the capability-related information may indicate at least one set of capability-related parameters supported by the terminal device 120 (such as, L sets of capability parameters). In some embodiments, the value of L may be a positive integer. For example, the value of L may be one of {1, 2, 3, 4, 5, 6, 7, 8}.

The capability parameters comprised in the set may be any suitable parameters, including but not limited to:
identity information of the set of capability parameters,
a maximum number of SRS ports,
a coherent type,
a maximum number of uplink layers,
a maximum number of downlink layers,
a maximum number of RS ports,
a maximum number of codewords, or
a maximum number of MIMO layers.

In some embodiments, the coherent type may be one of “fullyCoherent”, “fullyAndPartialAndNonCoherent”, “partialCoherent”, “partialAndNonCoherent” and “nonCoherent”. It is to be understood that the above coherent type are only for the purpose of illustration without suggesting any limitations. In some other example embodiments, any other coherent type may be configured.

As discussed above, the network device 110 also may transmit 220 the related configuration to the terminal device 120. In one example embodiment, the related configuration may be generated based on the capability-related information received from the terminal device 120. In another example embodiment, the measurement configuration is generated independently from the capability-related information.

In some embodiments, the network device 110 may configure the terminal device 120 to report the CSI report associated with a set of capability parameters periodically. Alternatively, in some other embodiments, the network device 110 may allocate semi-persistent resource for the terminal device 120 for transmitting the CSI report associated with a set of capability parameters. Alternatively, in some other embodiments, the network device 110 also may transmit a message to trigger the terminal device 120 to report an aperiodic CSI report associated with a set of capability parameters.

In addition, either the network device 110 or the terminal deive 120 may determine a subset of the sets of capability-related parameters supported by the terminal device, i.e, W sets of capability-related parameters, which means that in a following period, the terminal device 120 may only select/switch among the W sets of capability-related parameters. The information about the W sets of capability-related parameters may be exchanged between the terminal device 120 and the network device 110 via any suitable interaction procedures. In some embodiments, the value of W may be a positive integer. For example, the value of W may be 1<=W<=L.

It should be understand that all the above discussed procedure(s) may be performed more than once and on demand. For example, the W sets of capability-related parameters may be dynamically determined by either the network device 110 or the terminal deive 120 on demand.

With the above discussed procedure(s), the efficient CSI reporting is enabled. In some embodiments, if the CSI report is associated with a set of capability-related parameters, the CSI report (along with pair of SSBRI/CRI and L1-RSRP/SINR) may comprise a related identity information (for example, an information element or filed in the CSI report). One example of the related identity information is an index of the set of capability parameters. Another example of the related identity information is an index of the panel. A further example of the related identity information is information about a panel type of the panel (such as, defining the number of SRS ports corresponding to the panel).

In some embodiments, the related identity information corresponds to the panel that is expected to be used by the terminal device 120 to performing a UL transmission.

In some embodiments, the first index or the index Cn may indicate or include: an index of the related panel, an index of a set of capability parameters or an index of reserved state or a reserved bit value. For example, the reserved state or the reserved bit value may not correspond to any panel for uplink transmission or any set of capability parameters. In one example embodiments, the reserved state or the reserved bit value may correspond to downlink transmission only.

In some embodiment, a bit size of the identity information is determined based on a first number of sets of capability-related parameters supported by the terminal device 120 i.e., L. Specifically, the bit size is calculated as ceil (log₂(L)). In some embodiments, each value of the first index or the index Cn or each of the first or last L values in the ceil (log₂(L)) bit field of the identity information may indicate or include an index of the related panel or an index of a set of capability parameters.

Additionally, a specific index may be assigned for a DL-only CSI report, which means that the CSI with such specific index is associated with a DL transmission.

Considering this specific index, the bit size of the identity information is determined based on an addition of the first number of sets of capability-related parameters supported by the terminal device 120 and “1”, i.e., L+1. Specifically, the bit size is calculated as ceil (log₂(L+1)). In some embodiments, one value of the first index or the index Cn or the (L+1)-th value in the ceil (log₂(L+1)) bit field of the identity information may indicate or include an index of reserved state or a reserved bit value. For example, the reserved state or the reserved bit value may not correspond to any panel for uplink transmission or any set of capability parameters. In one example embodiments, the reserved state or the reserved bit value may correspond to downlink transmission only.

Alternately, as discussed above, the sets of capability-related parameters may be limited to a subset, i.e., W sets of capability-related parameters with a second number. In this event, the bit size of the identity information is determined based on the second number i.e., W. Specifically, the bit size is calculated as ceil (log₂(W)). In some embodiments, each value of the first index or the index Cn or each of the first or last W values in the ceil (log₂(W)) bit field of the identity information may indicate or include an index of the related panel or an index of a set of capability parameters.

Similarly, the specific index also may be considered. If so, the bit size of the identity information is determined based on an addition of the second number and “1”, i.e., W+1. Specifically, the bit size is calculated as ceil (log₂(W+1)). In some embodiments, one value of the first index or the index Cn or the (W+1)-th value in the ceil (log₂(W+1)) bit field of the identity information may indicate or include an index of reserved state or a reserved bit value. For example, the reserved state or the reserved bit value may not correspond to any panel for uplink transmission or any set of capability parameters. In one example embodiments, the reserved state or the reserved bit value may correspond to downlink transmission only.

It should be understood that the above illustrated interaction procedures are only for the purpose of illustration without suggesting any limitations. In some other example embodiments, any suitable other interaction procedures may be performed.

### Example Processes for Initial Transmission

Generally speaking, upon a powering on or a cell selection procedure, the terminal device 120 may re-access the communication network, which means that the terminal device 120 has not transmitted a CSI report associated with a set of capability parameters. So far, it is still pending about which panel/set of capability parameters may be used for performing the DL and/or UL transmission with the network device 110 for such specific scenario (i.e., before reporting the first/initial instance of the CSI report associated with a set of capability parameters or after an acknowledgement (ACK) for the first/initial instance of the CSI report). In the following embodiments, this pending issue may be well handled.

In the specific example embodiment of FIG. 2, the terminal device 120 performs 230 an initial transmission with the network device 110 by using a default set of capability parameters. The default set of capability parameters may be determined by any suitable policy/rule. In one example embodiment, the set of capability parameters with the minimum/maximum/pre-configured index value may be used as the default set of capability parameters. Alternately, in another example embodiment, the set of capability parameters with the minimum/maximum number of SRS ports may be used as the default set of capability parameters. Alternately, in another example embodiment, the set of capability parameters with a lower or lowest value of index may be used as the default set of capability parameters. Accordingly, in a further example embodiment, other policy/rule may be applied for determining the default set of capability parameters.

Additionally, the default set of capability parameters may be determined from all of the sets of capability parameters supported by the terminal device 120 (such as, L sets of capability parameters). Alternatively, the default set of capability parameters may be determined from a subset of the sets of capability parameters supported by the terminal device 120 (such as, W sets of capability parameters). Further, the subset may be determined by the terminal device 120.

Specifically, the terminal device 120 is deployed with L panels, and the L panels correspond to L sets of capability parameters. When performing the initial transmission, the terminal device 120 may determine a default set of capability parameters (such as, the set of capability parameters with index Cn=0) from the L/W sets of capability parameters as discussed above.

In some embodiments, the terminal device 120 transmits a CSI report associated with a set of capability parameters during a random access (RA) procedure. Specifically, the CSI report associated with a set of capability parameters is carried on one physical random access channel (PRACH). In one example embodiment, the CSI report associated with a set of capability parameters is included in a message 3 during a 4-step RA. Alternately, in another example embodiment, the CSI report associated with a set of capability parameters is included in a message A during a 2-step RA.

In this way, the original transmission between the terminal device 120 and the network device 110 is well handled.

### Example Processes for Determining Priority Value

As discussed above, in the related solution, each CSI report to be transmitted should be calculated with a priority value, and the CSI reports should be transmitted based on the priority values. In this way, if the terminal device 120 is in under an overload situation, the important CSI report also may be transmitted to the network device 110 in time. However, the related solution is irreverent with an association relationship between the CSI report and a set of capability parameters. According to the embodiments of the present discourse, the priority value for a CSI report is determined at least in part based on an association relationship between the first CSI report and a set of capability parameters. In other words, the priority value maybe adjusted based on the association relationship between the CSI report and a set of capability parameters.

Still refer to FIG. 2, the terminal device 120 determines 240 a first priority value of a first CSI report based on the association relationship between the CSI report and a set of capability parameters. Next, the terminal device 120 transmits 250 the first CSI based on the determined priority value.

Additionally, as discussed above, a CSI report associated with a set of capability parameters may comprise the related identity information (such as, an index of the set of capability parameters and an index of the panel), and the related identity information indicate the panel which is expected to be used by the terminal device 120. In some embodiments, the related identity information may be represented as a first index or index Cn in this disclosure. Thus, it seems that at least for some scenario, the CSI report associated with a set of capability parameters is more important compared with the other CSI reports. According to the embodiments of the present discourse, the CSI report associated with a set of capability parameters may be adjusted to be corresponding to a higher priority level.

Further, in some embodiments, in addition to the association relationship between the CSI report and a set of capability parameters, a plurality of other factors also may be used for determining the priority value of a CSI report. In this way, a feasibly solution for calculating the priority value is achieved, which may satisfy the requirements of different scenarios.

One example factor is a time-domain behavior of the CSI report, where the time-domain behavior may be a periodic time domain behavior, an aperiodic time domain behavior, or a semi-persistent time domain behavior. Another example factor is a cell index corresponding to the CSI report. A further example factor is a band identity corresponding to the first CSI report. The other example factors may be an identity of the CSI report, a determination whether the CSI report carries a signal quality measurement result and the identity information of the panel and so on.

It is to be understood that the above example factors are only for the purpose of illustration without suggesting any limitations. In some other example embodiments, any suitable other factors may be applied for determining the priority value.

As a general policy, the terminal device 120 may determine one or more factor to adjust the priority value according to different requirement of the different application scenarios.

In some embodiments, a priority rule may be used for determining the priority value. In particular, the priority rule may be associated with at least one first parameter defined for a situation that the CSI report is associated with a set of capability parameters. Alternatively, or in addition, the priority rule may be associated with at least one second parameter defined for a situation that the first CSI report is not associated with a set of capability parameters.

In this way, the determined priority value is different according to different association relationships between the CSI report and a set of capability parameters. Additionally, the at least one first parameter and the at least one second parameter may be associated with one or the above discussed factors.

Further, considering the CSI associated with a set of capability parameters is relative important, in some embodiments, the at least one first parameter are defined to enable the priority value corresponding to a higher priority level. Correspondingly, in some embodiments, the at least one second parameter are defined to enable the priority value corresponding to a lower priority level.

Additionally, in some embodiments, the priority rule of the present disclosure is implemented by re-defining the priority rule in the current related solution. In this way, a better backward compatibility is achieved.

In the following, some specific example embodiments will be discussed. It is to be clarified that all the below embodiments are only for the purpose of illustration without suggesting any limitations.

In some embodiments, the first CSI report may carry or include at least one pair of SSBRI/CRI and L1-RSRP/L1-SINR and a field of the first index or index Cn (or at least one value of the first index or index Cn). In one specific example embodiment, each pair of SSBRI/CRI and L1-RSRP/L1-SINR may correspond to one value of the first index or index Cn. In another specific example embodiment, all pairs of SSBRI/CRI and L1-RSRP/L1-SINR may correspond to a same value of the first index or index Cn. In a further specific example embodiment, the at least one pair of SSBRI/CRI and L1-RSRP/L1-SINR may correspond to a value of the first index or index Cn, wherein the value may correspond to a set of capability parameters. In other specific example embodiment, there may be at least one pair of SSBRI/CRI and L1-RSRP/L1-SINR corresponding to a value of the first index or index Cn, wherein the value may correspond to a set of capability parameters.

In one specific example embodiment, the values of the first index or index Cn in the at least one pair of SSBRI/CRI and L1-RSRP/L1-SINR should be same. In another specific example embodiment, there may be at least one pair of SSBRI/CRI and L1-RSRP/L1-SINR corresponding to a value of the first index or index Cn, wherein the value may not correspond to a set of capability parameters or may be the reserved bit value or the reserved state. In a further specific example embodiment, there may be no pair of SSBRI/CRI and L1-RSRP/L1-SINR corresponding to a value of the first index or index Cn, wherein the value may not correspond to a set of capability parameters or may be the reserved bit value or the reserved state.

In some embodiment, if the first CSI report is associated with a set of capability parameters, a first priority level of the first CSI report is higher than a second priority level of a second CSI report that is not associated with a set of capability parameters. In some embodiments, if a first priority value of the first CSI report is smaller than a second priority value of the second CSI report, the first priority level of the first CSI report is higher than the second priority level of the second CSI report.

In some embodiments, a first priority level of the first CSI report (such as, carrying the first index or the index Cn, or associated with the reserved state or the reserved bit value) may be higher than a second priority level of a second CSI report not carrying the first index or the index Cn. In some embodiments, if a first priority value of the first CSI report may is smaller than a second priority value of the second CSI report, the first priority level of the first CSI report is higher than the second priority level of the second CSI report.

In some embodiments, the second CSI report may not carry or include a value or a field of the first index or index Cn. In one specific example embodiment, the second CSI report may carry or include at least one pair of SSBRI/CRI and L1-RSRP/L1-SINR. In another example embodiment, the second CSI report may carry or include at least one of channel quality indicator (CQI), CRI, layer indicator (LI), rank indicator (RI), precoding matrix indicator (PMI) and a wideband indication i1 (for example, i1 may be an indication related to wideband PMI).

Additionally, a first priority level of the first CSI report may be conditionally higher than a second priority level of a second CSI report that is not associated with a set of capability parameters as discussed below.

In some embodiments, the first priority level of the first CSI report is higher than the second priority level of the second CSI report if the first CSI report and the second CSI report are configured with a same time-domain behavior. Additionally, the second CSI report may carry or not carry a signal quality measurement result (such as, L1-RSRP and L1-SINR). Some specific example embodiments are discussed as below.

In some embodiments, in case that more than one CSI report are configured with a same time domain behavior and/or carried on the same channel (such as PUCCH and PUSCH), the first priority level of a first CSI report associated with a set of capability parameters (for example, including index Cn) is higher than a second priority level of the second CSI report, where the second CSI report is not associated with a set of capability parameters (for example, without index Cn) and carries a signal measurement result (such as, L1-RSRP and L1-SINR).

In one specific example embodiment, the first and second CSI reports may correspond to either the same or different CCs. For example, the different CCs may be included in a same band or band combination. Additionally, the first and second CSI reports may correspond to either the same or different cells or frequency bands.

In one specific example embodiment, in case that the first and second CSI reports are configured with a same time domain behavior and carried on the same channel (such as PUCCH and PUSCH) and further associated with same cell, the priority values may be calculated as below Equation (2) or (3), where Equation (2) newly-introduces a parameter f and Equation (3) re-defines parameter k.

$${Pri}_{iCSI} ( y , k , c , s ) = 2 \cdot {N}_{cells} \cdot {M}_{s} \cdot y + {N}_{cells} \cdot {M}_{s} \cdot k + {M}_{s} \cdot c + s + f \qquad ( 2 )$$

where
y=0 for aperiodic CSI reports to be carried on PUSCH y=1 for semi-persistent CSI reports to be carried on PUSCH, y=2 for semi-persistent CSI reports to be carried on PUCCH and y=3 for periodic CSI reports to be carried on PUCCH;
k=0 for CSI reports carrying L1-RSRP or L1-SINR and k=1 for CSI reports not carrying L1-RSRP or L1-SINR;
for a CSI report associated with a set of capability parameters (i.e., CSI report carrying Cn and L1-RSRP or L1-SINR), f is a negative value within a certain value range (such as, f=−0.5 or any decimal value within (−1, 0)); otherwise, f=0;
c is the serving cell index and N_{cells} is the value of the higher layer parameter maxNrofServingCells;
s is the reportConfigID and Mₛ is the value of the higher layer parameter maxNrofCSI-ReportConfigurations.

$${Pri}_{iCSI} ( y , k , c , s ) = 3 \cdot {N}_{cells} \cdot {M}_{s} \cdot y + {N}_{cells} \cdot {M}_{s} \cdot k + {M}_{s} \cdot c + s \qquad ( 3 )$$

where
y=0 for aperiodic CSI reports to be carried on PUSCH y=1 for semi-persistent CSI reports to be carried on PUSCH, y=2 for semi-persistent CSI reports to be carried on PUCCH and y=3 for periodic CSI reports to be carried on PUCCH;
k=0 for a CSI report associated with a set of capability parameters (i.e., CSI report carrying Cn and L1-RSRP or L1-SINR); k=1 for a CSI report carrying L1-RSRP or L1-SINR and not associated with a set of capability parameters (i.e, CSI report carrying L1-RSRP or L1-SINR without Cn) and k=2 for CSI reports not carrying L1-RSRP or L1-SINR;
c is the serving cell index and N_{cells} is the value of the higher layer parameter maxNrofServingCells;
s is the reportConfigID and Mₛ is the value of the higher layer parameter maxNrofCSI-ReportConfigurations.

In this way, in case that the first and second CSI reports are configured with a same time domain behavior (i.e., with the same value of parameter y), the priority level of the CSI associated with a set of capability parameters is increased.

In one specific example embodiment, in case that the first and second CSI reports are configured with a same time domain behavior and carried on the same channel (such as PUCCH and PUSCH) and further the first and second CSI reports are corresponding to different CCs, the priority values also may be calculated as below as below Equation (4), where parameter H is newly introduced.

$${Pri}_{iCSI} ( y , k , c , s ) = 2 \cdot {N}_{cells} \cdot {M}_{s} \cdot y + {N}_{cells} \cdot {M}_{s} \cdot k + ( {M}_{s} \cdot c + s ) / H \qquad ( 4 )$$

where
y=0 for aperiodic CSI reports to be carried on PUSCH y=1 for semi-persistent CSI reports to be carried on PUSCH, y=2 for semi-persistent CSI reports to be carried on PUCCH and y=3 for periodic CSI reports to be carried on PUCCH;
k=0 for CSI reports carrying L1-RSRP or L1-SINR and k=1 for CSI reports not carrying L1-RSRP or L1-SINR;
for CSI report associated with a set of capability parameters (i.e., CSI report carrying Cn and L1-RSRP or L1-SINR), H is a positive value with a relative bigger value (such as, 2000, N_{cells}*Mₛ or any other suitable value); otherwise, H=0;
c is the serving cell index and N_{cells} is the value of the higher layer parameter maxNrofServingCells;
s is the reportConfigID and Mₛ is the value of the higher layer parameter maxNrofCSI-ReportConfigurations.

In this way, the priority level of a CSI associated with a set of capability parameters is increased. In particular, in case that there are multiple of CSI reports associated with a set of capability parameters, the priority values for the multiple of CSI reports still may be well handed, for example, may be determined based on the serving cell index and reportConfigID.

Further, it is assumed that as for a specific CC, there is only one CSI report associated with a set of capability parameters (i.e., carrying index Cn along with L1-RSRP/SINR). There are a plurality of manners to increase the priority value for the CSI report associated with a set of capability parameters.

In one example embodiment, the priority value for the CSI report may be calculated as Equation (2) as discussed above. Alternatively, or in addition, in another example embodiment, the priority value may be calculated as below Equation (5), where parameter c is re-defined.

$${Pri}_{iCSI} ( y , k , c , s ) = 2 \cdot {N}_{cells} \cdot {M}_{s} \cdot y + {N}_{cells} \cdot {M}_{s} \cdot k + {M}_{s} \cdot c + s \qquad ( 5 )$$

where
y=0 for aperiodic CSI reports to be carried on PUSCH y=1 for semi-persistent CSI reports to be carried on PUSCH, y=2 for semi-persistent CSI reports to be carried on PUCCH and y=3 for periodic CSI reports to be carried on PUCCH;
k=0 for CSI reports carrying L1-RSRP or L1-SINR and k=1 for CSI reports not carrying L1-RSRP or L1-SINR;
for CSI report associated with a set of capability parameters (i.e., CSI report carrying Cn and L1-RSRP or L1-SINR), c is the smallest value for serving cell among CSI reports (e.g., overlapping in at least one OFDM symbol and transmitted on the same carrier) or c=0; otherwise, c is the serving cell index and N_{cells} is the value of the higher layer parameter maxNrofServingCells;
s is the reportConfigID and Mₛ is the value of the higher layer parameter maxNrofCSI-ReportConfigurations.

Alternatively, or in addition, in a further example embodiment, the priority value may be calculated as below Equation (6), where parameter s is re-defined.

$${Pri}_{iCSI} ( y , k , c , s ) = 2 \cdot {N}_{cells} \cdot {M}_{s} \cdot y + {N}_{cells} \cdot {M}_{s} \cdot k + {M}_{s} \cdot c + s \qquad ( 6 )$$

where
y=0 for aperiodic CSI reports to be carried on PUSCH y=1 for semi-persistent CSI reports to be carried on PUSCH, y=2 for semi-persistent CSI reports to be carried on PUCCH and y=3 for periodic CSI reports to be carried on PUCCH;
k=0 for CSI reports carrying L1-RSRP or L1-SINR and k=1 for CSI reports not carrying L1-RSRP or L1-SINR;
c is the serving cell index and N_{cells} is the value of the higher layer parameter maxNrofServingCells;
for CSI report associated with a set of capability parameters (i.e., CSI report carrying Cn and L1-RSRP or L1-SINR), s is the smallest value reportConfigID among CSI reports (e.g., overlapping in at least one OFDM symbol and transmitted on the same carrier) or s=0; otherwise, s is the reportConfigID and Ms is the value of the higher layer parameter maxNrofCSI-ReportConfigurations.

It should be understood that the above three discussed manners are only for the purpose of illustration without suggesting any limitations. In some other example embodiments, any suitable other manners may be used for adjusting the priority value. Further, such manners may be used either separately or in any suitable combinations. The present disclosure is not limited in this regard.

Further, it is assumed that for a specific frequency band, there is only one CSI report associated with a set of capability parameters (i.e., carrying index Cn along with L1-RSRP/SINR). In other words, it is expected that the first and second cell indexes are associated with a same frequency band. For example, there may be at least one cells or CCs configured in the same frequency band.

Additionally, if there are more than one CSI report associated with a set of capability parameters, and the more than one CSI report corresponds to different frequency bands, the priority relationship among the more than one CSI report may be determined based on in the identity information of the different frequency bands (such as, the index of the frequency bands). Specifically, the priority values may be calculated as below as below Equation (7).

$${Pri}_{iCSI} ( y , k , c , s ) = 2 \cdot {N}_{cells} \cdot {M}_{s} \cdot y + {N}_{cells} \cdot {M}_{s} \cdot k + {M}_{s} \cdot c + s - b / B \qquad ( 7 )$$

where
y=0 for aperiodic CSI reports to be carried on PUSCH y=1 for semi-persistent CSI reports to be carried on PUSCH, y=2 for semi-persistent CSI reports to be carried on PUCCH and y=3 for periodic CSI reports to be carried on PUCCH;
k=0 for CSI reports carrying L1-RSRP or L1-SINR and k=1 for CSI reports not carrying L1-RSRP or L1-SINR;
for CSI report associated with a set of capability parameters (i.e., CSI report carrying Cn and L1-RSRP or L1-SINR), b is the index of the frequency band and B is the maximum number of the frequency band or a pre-configured value (such as, 10); otherwise, b=0.
c is the serving cell index and N_{cells} is the value of the higher layer parameter maxNrofServingCells;
s is the reportConfigID and Mₛ is the value of the higher layer parameter maxNrofCSI-ReportConfigurations.

In addition, in case that the CSI reports correspond to different frequency bands, the manner to increase the priority value for the CSI report associated with a set of capability parameters may be improved by other manners.

In one example embodiment, parameter c may be re-defined. Specifically, for CSI report associated with a set of capability parameters (i.e., CSI report carrying Cn and L1-RSRP or L1-SINR), c is the smallest value for serving cell index among CSI reports (e.g. overlapping in at least one OFDM symbol and transmitted on the same carrier and/or related to serving cells within a same band) or c=0; otherwise c is the serving cell index and N_{cells} is the value of the higher layer parameter maxNrofServingCells.

Alternatively, or in addition, in another example embodiment, parameter s may be re-defined. Specifically, for CSI report associated with a set of capability parameters (i.e., CSI report carrying Cn and L1-RSRP or L1-SINR), s is the smallest value for the reportConfigID among CSI reports (e.g. overlapping in at least one OFDM symbol and transmitted on the same carrier and/or related to serving cells within a same band) or s=0 for CSI reports carrying index Cn along with L1-RSRP or L1-SINR, otherwise s is the reportConfigID and is the value of the higher layer parameter maxNrofCSI-ReportConfigurations.

Similarly, the above manners also may be used either separately or in any suitable combinations. The present disclosure is not limited in this regard.

As discussed above, the CSI report associated with a set of capability parameters may be in any suitable time-domain behavior (such as, a periodic time domain behavior, an aperiodic time domain behavior, and a semi-persistent time domain behavior). In the following, some specific example embodiments with regards to the time domain behavior will be discussed.

In some embodiments, the first priority level of a first CSI report is associated with a set of capability parameters is higher than the second priority level of a second CSI report not associated with a set of capability parameters regardless of time-domain behaviors configured to the first and second CSI reports.

Alternatively, in some embodiments, the first priority level of a first CSI report is higher than the second priority level only if the second CSI report is configured with a certain time-domain behavior. In one specific example embodiment, in case that a first CSI report not is configured with a periodic or aperiodic time domain behavior, the first priority level is higher than the second priority level configured with an aperiodic/semi-persistent/periodic time domain behavior. Similarly, in case that a first CSI report not is configured with a semi-persistent time domain behavior, the first priority level is higher than the second priority level configured with a semi-persistent/periodic time domain behavior/periodic time domain behavior.

In one specific embodiment, the priority values may be calculated as below as below Equation (8), where parameter y is re-defined.

$${Pri}_{iCSI} ( y , k , c , s ) = 2 \cdot {N}_{cells} \cdot {M}_{s} \cdot y + {N}_{cells} \cdot {M}_{s} \cdot k + {M}_{s} \cdot c + s \qquad ( 8 )$$

where
y=0 for aperiodic CSI reports to be carried on PUSCH or CSI reports associated with a set of capability parameters (regardless of the time dominion behavior and the channel), y=1 for semi-persistent CSI reports to be carried on PUSCH, y=2 for semi-persistent CSI reports to be carried on PUCCH and y=3 for periodic CSI reports to be carried on PUCCH;
k=0 for CSI reports carrying L1-RSRP or L1-SINR and k=1 for CSI reports not carrying L1-RSRP or L1-SINR;
c is the serving cell index and N_{cells} is the value of the higher layer parameter maxNrofServingCells;
s is the reportConfigID and Mₛ is the value of the higher layer parameter maxNrofCSI-ReportConfigurations.

Additionally, in some specific embodiments, the parameter y may be re-defined further based on the time-domain behavior of the CSI report. For example, the priority value may be further demined based on a priority order of different time-domain behavior. One example of the priority order is an ascending order of an aperiodic time domain behavior, a semi-persistent time domain behavior and a periodic time domain behavior. In one specific example embodiment, the priority level of a first CSI report with an aperiodic time domain behavior is higher than the priority level of a second CSI report with a semi-persistent time domain behavior and/or a periodic time domain behavior. Alternatively, in another specific example embodiment, the priority of a first CSI report with a semi-persistent time domain behavior is higher than the priority of a second CSI report with a periodic time domain behavior. Another example of the priority order is an ascending order of a periodic time domain behavior, an aperiodic time domain behavior, and a semi-persistent time domain behavior. It is to be understood that in other example embodiments, other priority orders may be applied.

In one specific embodiment, the priority values may be calculated as below as below Equation (9), where parameter y is further re-defined.

$${Pri}_{iCSI} ( y , k , c , s ) = 2 \cdot {N}_{cells} \cdot {M}_{s} \cdot y + {N}_{cells} \cdot {M}_{s} \cdot k + {M}_{s} \cdot c + s \qquad ( 9 )$$

where
y=0 for aperiodic CSI reports associated with a set of capability parameters and to be carried on PUSCH, y=1 for aperiodic CSI reports not associated with a set of capability parameters and to be carried on PUSCH, y=2 for semi-persistent CSI reports associated with a set of capability parameters and to be carried on PUSCH, y=3 for semi-persistent CSI reports not associated with a set of capability parameters and to be carried on PUSCH, y=4 for semi-persistent CSI reports associated with a set of capability parameters and to be carried on PUCCH, y=5 semi-persistent CSI reports not associated with a set of capability parameters and to be carried on PUCCH, y=6 for periodic CSI reports associated with a set of capability parameters and to be carried on PUCCH, and y=7 for periodic CSI reports not associated with a set of capability parameters and to be carried on PUCCH;
k=0 for CSI reports carrying L1-RSRP or L1-SINR and k=1 for CSI reports not carrying L1-RSRP or L1-SINR;
c is the serving cell index and N_{cells} is the value of the higher layer parameter maxNrofServingCells;
s is the reportConfigID and Mₛ is the value of the higher layer parameter maxNrofCSI-ReportConfigurations.

Alternatively, in another specific embodiment where parameter y is re-defined, the priority values may be calculated as below as below Equation (10)

$${Pri}_{iCSI} ( y , k , c , s ) = 2 \cdot {N}_{cells} \cdot {M}_{s} \cdot y + {N}_{cells} \cdot {M}_{s} \cdot k + {M}_{s} \cdot c + s \qquad ( 10 )$$

where
For CSI report not associated with a set of capability parameters y=0 for aperiodic CSI reports to be carried on PUSCH, y=1 for semi-persistent CSI reports to be carried on PUSCH, y=2 for semi-persistent CSI reports to be carried on PUCCH and y=3 for periodic CSI reports to be carried on PUCCH;
For CSI report associated with a set of capability parameters y=0 for periodic CSI reports to be carried on PUCCH, y=1 for semi-persistent CSI reports to be carried on PUSCH, y=2 for semi-persistent CSI reports to be carried on PUCCH and y=3 for aperiodic CSI reports to be carried on PUSCH;
k=0 for CSI reports carrying L1-RSRP or L1-SINR and k=1 for CSI reports not carrying L1-RSRP or L1-SINR;
c is the serving cell index and N_{cells} is the value of the higher layer parameter maxNrofServingCells;
s is the reportConfigID and Mₛ is the value of the higher layer parameter maxNrofCSI-ReportConfigurations.

It should be understood that, the above specific embodiment where parameter y is re-defined are only for the purpose of illustration without suggesting any limitations. In some other example embodiments, parameter y may be re-defined in any suitable manner. The present disclosure is not limited in this regard.

Alternatively, the priority value of the CSI report a set of capability parameters may be defined to be a default priority value corresponding to a higher priority level directly.

Additionally, the default priority value is determined based on a minimum priority value and/or a time-domain behavior of the first CSI report.

In some embodiments, the priority value of the CSI report associated with a set of capability parameters is determined to be a value smaller than the min (Pri_{iCSI}(y, k, c, s)), for example, min (Pri_{iCSI}(y, k, c, s))−T, wherein T is offset with a non-negative integer value (for example 0<=T<=3).

Additionally, the value of T may be determined based on different time domain behavior.

In one specific example embodiment, T may be configured to be a default value (such as, T=1) for CSI report associated with a set of capability parameters regardless of the time domain behavior.

Alternatively, in another specific example embodiment, different values of T may be defined for different time domain behaviors. For example, T=1 for periodic report X, T=2 for semi-persistent report X and T=3 for aperiodic report X, or T=1 for aperiodic report X, T=2 for semi-persistent report X and T=3 for periodic report X.

According to the above discussion, when a CSI report associated with a set of capability parameters is supported in the communication system, the priority level for the CSI reports also may be well handled.

It is to be understood that all the above discussed example embodiments are only for the purpose of illustration without suggesting any limitations. The specific manner for determining the priority value may be modified based on the teaching of the above discussed example embodiments, such modified embodiment should also be considered within the scope of this disclosure.

### Example Processes for Avoiding Confusion

As discussed above, a CSI report associated with the first index or index Cn or associated with a set of capability parameters may indicate the related identity information (such as, an index of the set of capability parameters and an index of the panel) that which is expected to be used by the terminal device 120. In this event, the network device 110 may be confused if the terminal device 120 transmits more than one panel-related CSI report. According to the following embodiments, this confusion may be voided

Specifically, it is assumed that for a specific frequency band, there is only one CSI report associated with a set of capability parameters or associated with the first index or index Cn. In addition, there may be at least one cells or CCs configured in the specific frequency band. Further, there are multiple CSI reports with time occupancy of the physical channels scheduled to carry the CSI reports overlapping in at least one OFDM symbol and/or are transmitted on the same carrier. In this event, the below operation is expected at the terminal device 120.

In one specific example embodiments, if there are a first and second CSI reports both of which are associated with a set of capability parameters or associated with the first index or index Cn, the terminal device 120 selects a CSI report to carry identity information of a set of capability parameters or associated with the first index or index Cn from the first and second CSI reports, for example, selecting a CSI report associated with one value of certain serving cell index, e.g. c=0 or lowest value of serving cell indexes (across CCs and/or within a frequency band).

Alternatively, in another specific example embodiment, if there are a first and second CSI reports both of which are associated with a set of capability parameters or associated with the first index or index Cn, the terminal device 120 drops one of the first and second CSI reports. For example, if there are multiple CSI reports associated with a set of capability parameters, the terminal device 120 selects a CSI report associated with one value of certain serving cell index, e.g. c=0 or lowest value of serving cell indexes (across CCs and/or within a frequency band) and drops the other CSI reports.

Alternatively, in a further specific example embodiment, if there are a first and second CSI reports both of which are associated with a set of capability parameters or associated with the first index or index Cn, the terminal device 120 comprises a same identity information of a set of capability parameters in the first and second CSI reports. In other word, if there are multiple CSI reports associated with a set of capability parameters, the value of index Cn comprised in the multiple CSI reports is expected to be the same.

Alternatively, in a further specific example embodiment, if there are a first and second CSI reports both of which are associated with a set of capability parameters or associated with the first index or index Cn, the terminal device 120 may transmit both the first and second CSI reports to the network device 110. However, both the terminal device 120 and the network device 110 would understood that only one of first and second CSI reports is valid or applied, for example, the CSI report associated with the lowest value of serving cell index and/or report configuration identity (ID).

In this way, the confusion caused by more than one CSI reports associated with a set of capability parameters may be avoided accordingly.

### Example Processes for Transmission Requirement

In the related solutions, the minimum processing time should be determined for transmitting the CSI reports. However, the processing time for a CSI report associated with a set of capability parameters may be different from the other CSI reports. According to some embodiments of the present discourse, the minimum processing time requirement may be re-defined. In other words, the terminal device 120 applies a minimum processing time specific to a CSI report associated with a set of capability parameters.

Additionally, in some embodiments, if a CSI report associated with a set of capability parameters, a new CSI processing time is applied and/or the CSI report will be reported regardless of whether processing time requirement is satisfied.

In some embodiments, the new CSI processing time is applied only when the CSI report is aperiodic.

In one specific example embodiment, the minimum processing time stipulated in standard in 3GPP TS 38. 214 is re-defined as below.
(Z₁₁, Z₁₁′) of the below table 1 if the CSI to be transmitted corresponds to wideband frequency-granularity where the reportQuantity is set to ‘ssb-Index-SINR-CnIndex’, or reportQuantity is set to ‘cri-SINR-CnIndex”, or
(Z₃₁, Z₃₁′) of the below table 1 if reportQuantity is set to ‘cri-RSRP-CnIndex” or ‘ssb-Index-RSRP-CnIndex”, where Xμ is a maximum value among multiple UE reported capabilities beamReportTiming and KB₁ is a maximum value among UE reported capabilities beamSwitchTiming as defined in standards 3GPP TS 38.306]

TABLE 1
CSI computation delay requirement 2

| | Z₁ [symbols] | | Z₂ [symbols] | | Z₃ [symbols] | |
|---|---|---|---|---|---|---|
| μ | Z₁ | Z′₁ | Z₂ | Z′₂ | Z₃ | Z′₃ |
| 0 | 22 | 16 | 40 | 37 | 22 | X₀ |
| 1 | 33 | 30 | 72 | 69 | 33 | X₁ |
| 2 | 44 | 42 | 141 | 140 | min(44, X₂ + KB₁) | X₂ |
| 3 | 97 | 85 | 152 | 140 | min(97, X₃ + KB₂) | X₃ |

In the related solutions, the CSI reported should satisfy some requirements, such as, a timeline requirement, a processing time requirement, a timing advance requirement, a minimum processing time requirement. However, as discussed above, the CSI associated with a set of capability parameters is relative important. According to some embodiments of the present discourse, the CSI associated with a set of capability parameters may be triggered/transmitted regardless of the above requirements.

In some embodiments, the above the terminal device 120 may conditionally ignore the above requirements, for example, when the CSI report is aperiodic.

In one specific example, the CSI associated with a set of capability parameters may be triggered/transmitted regardless of timeline requirement/a processing time requirement. Specifically, even if the processing time for PUSCH and/or CSI is less than threshold, the CSI report associated with a set of capability parameters is reported.

In some embodiments, if a semi-persistent CSI report to be carried on PUSCH overlaps in time with PUSCH data transmission in one or more symbols on the same carrier, and if the earliest symbol of these PUSCH channels starts no earlier than N₂+d₂, 1 symbols after the last symbol of the DCI scheduling the PUSCH where d_{2,1} is the maximum of the d_{2,1} associated with the PUSCH carrying semi-persistent CSI report and the PUSCH with data transmission, the CSI report shall be transmitted by the terminal device 120 if the CSI report associated with a set of capability parameters, otherwise the CSI report shall not be transmitted by the UE. Otherwise, if the timeline requirement is not satisfied and if the CSI report carries index Cn, the CSI report shall be transmitted by the terminal device 120 (padding bits on REs except for the CSI report), otherwise this is an error case.

In some embodiments, if the terminal device 120 would transmit a first PUSCH that includes semi-persistent CSI reports and a second PUSCH that includes an UL-SCH and the first PUSCH transmission would overlap in time with the second PUSCH transmission, the UE transmits the first PUSCH and does not transmit the second PUSCH if the CSI report carries index Cn, otherwise the terminal device 120 does not transmit the first PUSCH and transmits the second PUSCH. The terminal device 120 expects that the first and second PUSCH transmissions satisfy the above timing conditions for PUSCH transmissions that overlap in time when at least one of the first or second PUSCH transmissions is in response to a DCI format detection by the UE if the CSI report does not carry index Cn.

In one specific example, the CSI reports associated with a set of capability parameters may be triggered/transmitted regardless of whether the timing advance requirement is satisfied.

In some embodiments, when the CSI request field on a DCI triggers a CSI report(s) on PUSCH, the terminal device 120 shall provide a valid CSI report if the CSI report associated with a set of capability parameters, otherwise terminal device 120 shall provide a valid CSI report for the n-th triggered report,
if the first uplink symbol to carry the corresponding CSI report(s) including the effect of the timing advance, starts no earlier than at symbol Z_{ref}, and
if the first uplink symbol to carry the n-th CSI report including the effect of the timing advance, starts no earlier than at symbol Z′_{ref}(n),

where Z_{ref} is defined as the next uplink symbol with its CP starting T_{proc,CSI}=(Z)(2048+144)·κ2^{-μ}·T_{C}+T_{switch} after the end of the last symbol of the PDCCH triggering the CSI report(s), and where Z′_{ref}(n), is defined as the next uplink symbol with its CP starting T′_{proc,CSI}=(Z′)(2048+144)·κ2^{-μ}·T_{C} after the end of the last symbol in time of the latest of: aperiodic CSI-RS resource for channel measurements, aperiodic CSI-IM used for interference measurements, and aperiodic NZP CSI-RS for interference measurement, when aperiodic CSI-RS is used for channel measurement for the n-th triggered CSI report, and where T_{switch} is defined in clause 6.4 of 3GPP TS 38.214 and is applied only if Z₁ of table 5.4-1 is applied.

If the PUSCH indicated by the DCI is overlapping with another PUCCH or PUSCH, then the CSI report(s) are multiplexed following the procedure in clause 9.2.5 of standards of 3GPP TS 38.213 and clause 5.2.5 when applicable, otherwise the CSI report(s) are transmitted on the PUSCH indicated by the DCI.

When the CSI request field on a DCI triggers a CSI report(s) on PUSCH, if the first uplink symbol to carry the corresponding CSI report(s) including the effect of the timing advance, starts earlier than at symbol Z_{ref},
the terminal device 120 may ignore the scheduling DCI if no HARQ-ACK or transport block or index Cn is multiplexed on the PUSCH.

When the CSI request field on a DCI triggers a CSI report(s) on PUSCH, if the first uplink symbol to carry the n-th CSI report including the effect of the timing advance, starts earlier than at symbol Z′_{ref}(n),
the terminal device 120 may ignore the scheduling DCI if the number of triggered reports is one and no HARQ-ACK or transport block or index Cn is multiplexed on the PUSCH,
Otherwise, the terminal device 120 is not required to update the CSI except the value of index Cn if any for the n-th triggered CSI report.

In this way, the transmission of the CSI report associated with a set of capability parameters is guaranteed.

### Example Processes for Improving Reliability

Considering the CSI report associated with a set of capability parameters is relative more important, the reliability of such CSI report should be enhanced. According to some embodiments of the present discourse, a repetition number specific for the CSI report associated with a set of capability parameters is introduced.

Still refer to FIG. 2, the network device 110 transmits 220 a configuration indicating a repetition number for a CSI report associated with a set of capability parameters. Next, in response to a CSI report associated with a set of capability parameters being triggered, the terminal device 120 transmits the CSI report to the network device 110 based on the repetition number.

In one specific example embodiments, in the transmission occasion of the CSI report associated with a set of capability parameters, the CSI report would be transmitted for Rp times, wherein the repetition number Rp may be R+Rc or max (R, Rc), where R is the repetition number configured for PUCCH/PUSCH carrying the CSI report, or R=1 if no repetition configured, and Rc is a repetition number configured for or related to the CSI report carrying index Cn, where Rc and R is a positive integer. For example, Rc/R may be one of {1, 2, 3, 4, 5, 6, 7, 8, 16, 32, 64, 128}.

It is to be understood that other manners for enabling the repeat transmission for the panel-related CSI reports should also be considered as within the scope of the present discourse.

### Example Processes for Allocating the Transmission Power

As discussed above, when transmitting the CSI reports, the terminal device should allocate a transmission power among the CSI and other singles. According to some embodiments of the present discourse, in case that at least one CSI report is generated, the terminal device 120 allocates a transmission power among the at least one CSI report based on an association relationship between a CSI report and a set of capability parameters.

In some embodiments, the terminal device 120 prioritizes the allocation transmission power to a CSI associated with a set of capability parameters.

Alternatively, or in addition, the terminal device 120 allocates a transmission power among the at least one CSI report based on a time-domain behavior of a CSI report.

In some embodiments, the terminal device 120 allocates a transmission power among the at least one CSI report based on a priority order of different time-domain behavior. One example of the priority order is an aperiodic time domain behavior, a semi-persistent time domain behavior and a periodic time domain behavior. Another example of the priority order is a periodic time domain behavior, an aperiodic time domain behavior, and a semi-persistent time domain behavior. It is to be understood that in other example embodiments, other priority order may be applied.

In some embodiments, for single cell operation with two uplink carriers or for operation with carrier aggregation, if a total UE transmit power for PUSCH or PUCCH or PRACH or SRS transmissions on serving cells in a frequency range in a respective transmission occasion i would exceed \hat{P}_{CMAX}(i), where \hat{P}_{CMAX} (i) is the linear value of P_{CMAX} (i) in transmission occasion i as defined in standard 3GPP TS 38.101-1 for FR1 and standard 3GPP TS38.101-2 for FR2, the terminal device 120 allocates power to PUSCH/PUCCH/PRACH/SRS transmissions according to the following priority order (in descending order) so that the total UE transmit power for transmissions on serving cells in the frequency range is smaller than or equal to \hat{P}_{CMAX} (i) for that frequency range in every symbol of transmission occasion i. When determining a total transmit power for serving cells in a frequency range in a symbol of transmission occasion i, the UE does not include power for transmissions starting after the symbol of transmission occasion i. The total UE transmit power in a symbol of a slot is defined as the sum of the linear values of UE transmit powers for PUSCH, PUCCH, PRACH, and SRS in the symbol of the slot.
PRACH transmission on the primary cell (PCell);
PUCCH or PUSCH transmissions with higher priority index according to clause 9 of standard 3GPP TS 38. 214;
For PUCCH or PUSCH transmissions with same priority index;
PUCCH transmission with hybrid automatic repeat request (HARQ)-ACK information, and/or scheduling request (SR), and/or LRR and/or the first index and/or index Cn, or PUSCH transmission with HARQ-ACK information and/or the first index and/or index Cn;
PUCCH transmission with CSI or PUSCH transmission with CSI; further, the priority of CSI reports may be further defined as discussed above;
PUSCH transmission without HARQ-ACK information or CSI and, for Type-2 random access procedure, PUSCH transmission on the PCell;
SRS transmission, with aperiodic SRS having higher priority than semi-persistent and/or periodic SRS, or PRACH transmission on a serving cell other than the PCell.

In some embodiments, in case of same priority order and for operation with carrier aggregation, the terminal device 120 prioritizes power allocation for transmissions on the primary cell of the MCG or the SCG over transmissions on a secondary cell. In case of same priority order and for operation with two UL carriers, the terminal device 120 prioritizes power allocation for transmissions on the carrier where the UE is configured to transmit PUCCH. If PUCCH is not configured for any of the two UL carriers, the terminal device 120 prioritizes power allocation for transmissions on the non-supplementary UL carrier.

In this way, the transmit power for the CSI report associated with a set of capability parameters is guaranteed

### EXAMPLE METHODS

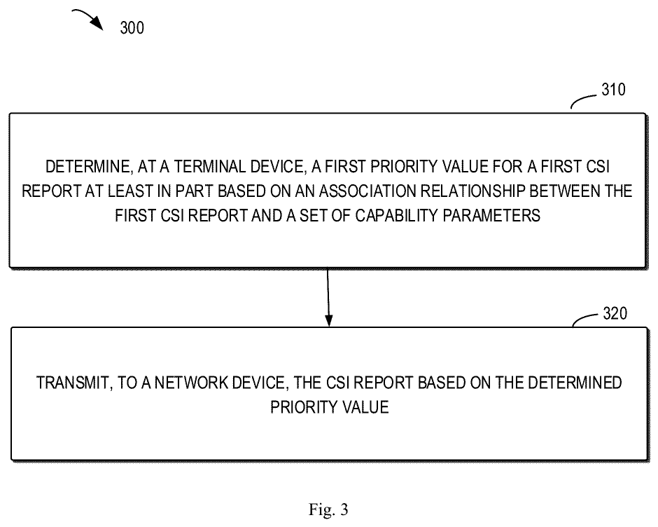

FIG. 3 illustrates a flowchart of an example method 300 in accordance with some embodiments of the present disclosure. For example, the method 300 can be implemented at the terminal device 120 as shown in FIG. 1.

At block 310, the terminal device 120 determines a first priority value for a first CSI report at least in part based on an association relationship between the first CSI report and a set of capability parameters.

At block 320, the terminal device 120 transmits the CSI report to a network device 110 based on the determined priority value.

In some embodiments, the terminal device 120 determines the first priority value further based on at least one of the following: a time-domain behavior of the first CSI report, the time-domain behavior being one of a periodic time domain behavior, an aperiodic time domain behavior, and a semi-persistent time domain behavior, a cell index corresponding to the first CSI report, a band identity corresponding to the first CSI report, an identity of the first CSI report, or a determination whether the first CSI report carries a signal quality measurement result.

In some embodiments, the terminal device 120 determines the first priority value based on a priority rule, the priority rule associated with at least one of the following: at least one first parameter defined for a situation that the first CSI report is associated with a set of capability parameters, or at least one second parameter defined for a situation that the first CSI report is not associated with a set of capability parameters.

In some embodiments, if the first CSI report is associated with a set of capability parameters, a first priority level of the first CSI report is higher than a second priority level of a second CSI report that is not associated with a set of capability parameters.

In some embodiments, the second CSI report carries a signal quality measurement result.

In some embodiments, the first CSI report is associated with a first cell index and the second CSI report is associated with a different second cell index.

In some embodiments, the first and second cell indexes are associated with a same frequency band.

In some embodiments, the first priority level is higher than the second priority level if the first CSI report and the second CSI report are configured with a same time-domain behavior.

In some embodiments, the first priority level is higher than the second priority level if the second CSI report is configured with a certain time-domain behavior.

In some embodiments, the first priority level is higher than the second priority level regardless of time-domain behaviors configured to the first and second CSI reports.

In some embodiments, the terminal device 120 determines, based on the time-domain behavior of the first CSI report, the first priority value according to a priority order of one of the following: an aperiodic time domain behavior, a semi-persistent time domain behavior and a periodic time domain behavior, or a periodic time domain behavior, an aperiodic time domain behavior, and a semi-persistent time domain behavior.

In some embodiments, the terminal device 120 determines the first priority value to be a default priority value corresponding to a higher priority level.

In some embodiments, the default priority value is determined based on at least one of the following: a minimum priority value, or a time-domain behavior of the first CSI report.

In some embodiments, the set of capability parameters correspond to a panel deployed on the terminal device 120; and the first CSI report comprises an identity information of one of the following: an index of the set of capability parameters, information about a panel type of the panel, or an index of the panel.

In some embodiments, a bit size of the identity information is determined based on at least one of the following: a first number of sets of capability-related parameters supported by the terminal device 120, or a second number smaller than the first number, the second number being determined either by the terminal or the network device 110.

In some embodiments, the terminal device 120 transmits capability-related information of the terminal device 120 to the network device 110, the capability-related information indicating at least one set of capability-related parameters, a set of capability parameters of the at least one set of capability parameters comprising at least one of the following: identity information of the set of capability parameters, a maximum number of SRS ports, a coherent type, a maximum number of uplink layers, a maximum number of downlink layers, a maximum number of RS ports, a maximum number of codewords, or a maximum number of MIMO layers.

In some embodiments, the terminal device 120 performs an initial transmission with the network device 110 by using a default set of capability parameters.

In some embodiments, the terminal device 120 transmits a CSI report associated with a set of capability parameters to the network device 110 during a RA procedure.

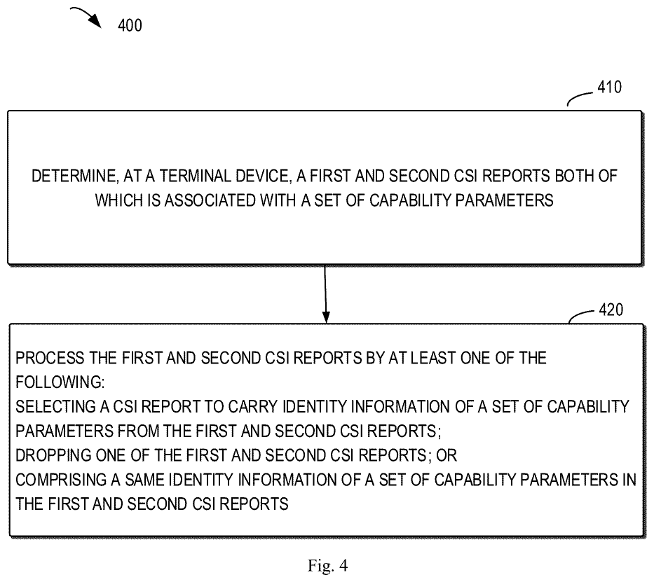

FIG. 4 illustrates a flowchart of an example method 400 in accordance with some embodiments of the present disclosure. For example, the method 400 can be implemented at the terminal device 120 as shown in FIG. 1.

At block 410, the terminal device 120 generates a first and second CSI reports both of which are associated with a set of capability parameters.

At block 420, the terminal device 120 processes the first and second CSI reports by at least one of the following: selecting a CSI report to carry identity information of a set of capability parameters from the first and second CSI reports; dropping one of the first and second CSI reports; or comprising a same identity information of a set of capability parameters in the first and second CSI reports.

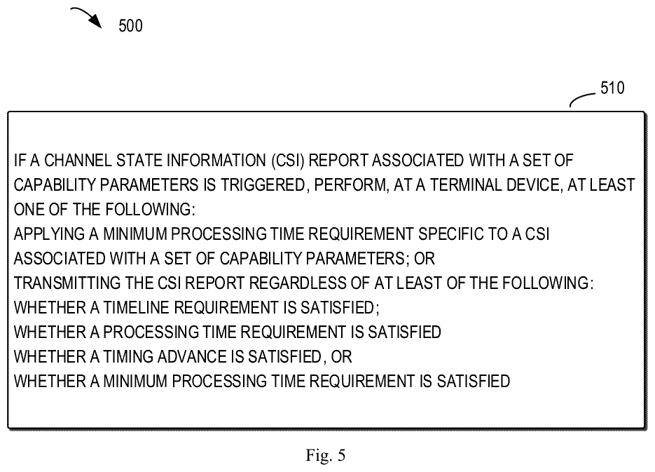

FIG. 5 illustrates a flowchart of an example method 500 in accordance with some embodiments of the present disclosure. For example, the method 500 can be implemented at the terminal device 120 as shown in FIG. 1.

At block 510, if a CSI report associated with a set of capability parameters is triggered, the terminal device 120 performs at least one of the following: applying a minimum processing time requirement specific to a CSI report associated with a set of capability parameters; or transmitting the CSI report regardless of at least of the following: whether a timeline requirement is satisfied; whether a processing time requirement is satisfied; whether a timing advance is satisfied; or whether a minimum processing time requirement is satisfied.

In some embodiments, the CSI report is aperiodic.

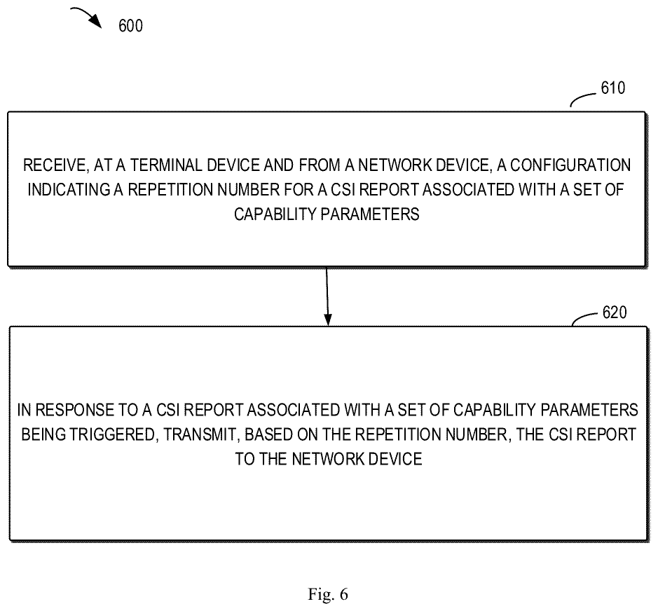

FIG. 6 illustrates a flowchart of an example method 600 in accordance with some embodiments of the present disclosure. For example, the method 600 can be implemented at the terminal device 120 as shown in FIG. 1.

At block 610, the terminal device 120 receives a configuration from a network device 110, the configuration indicating a repetition number for a CSI report associated with a set of capability parameters.

At block 620, in response to a CSI report associated with a set of capability parameters being triggered, the terminal device 120 transmits the CSI report to the network device 110 based on the repetition number.

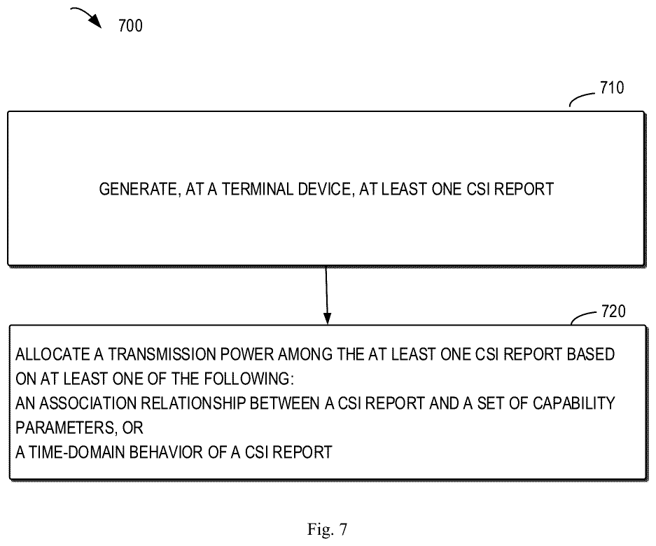

FIG. 7 illustrates a flowchart of an example method 700 in accordance with some embodiments of the present disclosure. For example, the method 700 can be implemented at the terminal device 120 as shown in FIG. 1.

At block 710, the terminal device 120 generates at least one CSI report.

At block 720, the terminal device 120 allocates a transmission power among the at least one CSI report based on at least one of the following: an association relationship between a CSI report and a set of capability parameters, or a time-domain behavior of a CSI report.

At block 710, the terminal device 120 prioritizes the allocation transmission power to a CSI associated with a set of capability parameters.

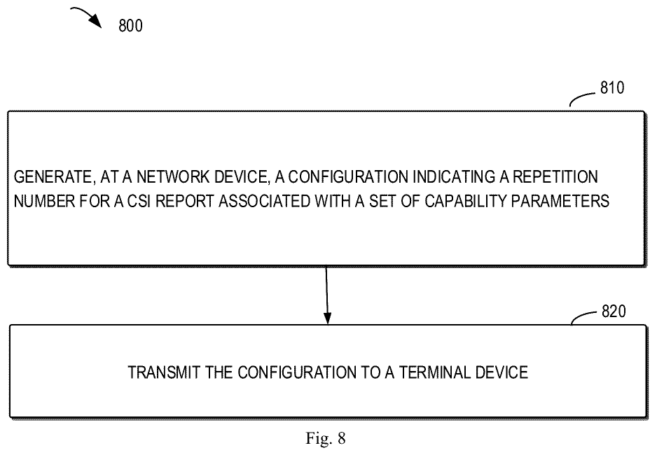

FIG. 8 illustrates a flowchart of an example method 800 in accordance with some embodiments of the present disclosure. For example, the method 800 can be implemented at the network device 110 as shown in FIG. 1.

At block 810, the network device 110 generates a configuration indicating a repetition number for a CSI report associated with a set of capability parameters.

At block 820, the network device 110 transmits the configuration to a terminal device 120.

### EXAMPLE DEVICES

In some example embodiments, the terminal device 110 comprises circuitry configured to: determine a first priority value for a first CSI report at least in part based on an association relationship between the first CSI report and a set of capability parameters; and transmit the CSI report to a network device based on the determined priority value.

In some example embodiments, the circuitry is further configured to: determine the first priority value further based on at least one of the following: a time-domain behavior of the first CSI report, the time-domain behavior being one of a periodic time domain behavior, an aperiodic time domain behavior, and a semi-persistent time domain behavior, a cell index corresponding to the first CSI report, a band identity corresponding to the first CSI report, an identity of the first CSI report, or a determination whether the first CSI report carries a signal quality measurement result.

In some example embodiments, the circuitry is further configured to: determine the first priority value based on a priority rule, the priority rule associated with at least one of the following: at least one first parameter defined for a situation that the first CSI report is associated with a set of capability parameters, or at least one second parameter defined for a situation that the first CSI report is not associated with a set of capability parameters.

In some example embodiments, if the first CSI report is associated with a set of capability parameters, a first priority level of the first CSI report is higher than a second priority level of a second CSI report that is not associated with a set of capability parameters.

In some example embodiments, the second CSI report carries a signal quality measurement result.

In some example embodiments, the first CSI report is associated with a first cell index and the second CSI report is associated with a different second cell index.

In some example embodiments, the first and second cell indexes are associated with a same frequency band.

In some example embodiments, the first priority level is higher than the second priority level if the first CSI report and the second CSI report are configured with a same time-domain behavior.

In some example embodiments, the first priority level is higher than the second priority level if the second CSI report is configured with a certain time-domain behavior.

In some example embodiments, the first priority level is higher than the second priority level regardless of time-domain behaviors configured to the first and second CSI reports.

In some example embodiments, the circuitry is further configured to: determine, based on the time-domain behavior of the first CSI report, the first priority value according to a priority order of one of the following: an aperiodic time domain behavior, a semi-persistent time domain behavior and a periodic time domain behavior, or a periodic time domain behavior, an aperiodic time domain behavior, and a semi-persistent time domain behavior.

In some example embodiments, the circuitry is further configured to: determine the first priority value to be a default priority value corresponding to a higher priority level.

In some example embodiments, the default priority value is determined based on at least one of the following: a minimum priority value, or a time-domain behavior of the first CSI report.

In some example embodiments, the set of capability parameters correspond to a panel deployed on the terminal device 120; and the first CSI report comprises an identity information of one of the following: an index of the set of capability parameters, information about a panel type of the panel, or an index of the panel.

In some example embodiments, a bit size of the identity information is determined based on at least one of the following: a first number of sets of capability-related parameters supported by the terminal device 120, or a second number smaller than the first number, the second number being determined either by the terminal or the network device 110.

In some example embodiments, the circuitry is further configured to: transmit capability-related information of the terminal device 120 to the network device 110, the capability-related information indicating at least one set of capability-related parameters, a set of capability parameters of the at least one set of capability parameters comprising at least one of the following: identity information of the set of capability parameters, a maximum number of SRS ports, a coherent type, a maximum number of uplink layers, a maximum number of downlink layers, a maximum number of RS ports, a maximum number of codewords, or a maximum number of MIMO layers.

In some example embodiments, the circuitry is further configured to: perform an initial transmission with the network device 110 by using a default set of capability parameters.

In some example embodiments, the circuitry is further configured to: transmit a CSI report associated with a set of capability parameters to the network device 110 during a RA procedure.

In some example embodiments, the terminal device 110 comprises circuitry configured to: generate a first and second CSI reports both of which are associated with a set of capability parameters; and process the first and second CSI reports by at least one of the following: selecting a CSI report to carry identity information of a set of capability parameters from the first and second CSI reports; dropping one of the first and second CSI reports; or comprising a same identity information of a set of capability parameters in the first and second CSI reports.

In some example embodiments, the terminal device 110 comprises circuitry configured to: if a CSI report associated with a set of capability parameters is triggered, performs at least one of the following: applying a minimum processing time requirement specific to a CSI report associated with a set of capability parameters; or transmitting the CSI report regardless of at least of the following: whether a timeline requirement is satisfied; whether a processing time requirement is satisfied; whether a timing advance is satisfied; or whether a minimum processing time requirement is satisfied.

In some example embodiments, the CSI report is aperiodic.

In some example embodiments, the terminal device 110 comprises circuitry configured to: receive a configuration from a network device 110, the configuration indicating a repetition number for a CSI report associated with a set of capability parameters; and in response to a CSI report associated with a set of capability parameters being triggered, transmit the CSI report to the network device 110 based on the repetition number.

In some example embodiments, the terminal device 120 comprises circuitry configured to: generates at least one CSI report; and allocate a transmission power among the at least one CSI report based on at least one of the following: an association relationship between a CSI report and a set of capability parameters, or a time-domain behavior of a CSI report.

In some example embodiments, the circuitry is further configured to: prioritize the allocation transmission power to a CSI associated with a set of capability parameters.

In some example embodiments, the network device 120 comprises circuitry configured to: generate a configuration indicating a repetition number for a CSI report associated with a set of capability parameters; and transmit the configuration to a terminal device 120.

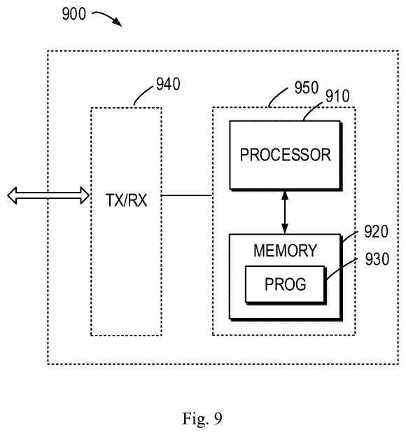

FIG. 9 is a simplified block diagram of a device 900 that is suitable for implementing embodiments of the present disclosure. The device 900 can be considered as a further example implementation of the terminal 120 and the network device 110 as shown in FIG. 1. Accordingly, the device 900 can be implemented at or as at least a part of the terminal 120 and the network device 110.

As shown, the device 900 includes a processor 99, a memory 920 coupled to the processor 910, a suitable transmitter (TX) and receiver (RX) 940 coupled to the processor 910, and a communication interface coupled to the TX/RX 940. The memory 920 stores at least a part of a program 930. The TX/RX 940 is for bidirectional communications. The TX/RX 940 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the CNB, Un interface for communication between the eNB and a relay node (RN), or Uu interface for communication between the eNB and a terminal device.

The program 930 is assumed to include program instructions that, when executed by the associated processor 910, enable the device 900 to operate in accordance with the embodiments of the present disclosure, as discussed herein with reference to FIGS. 3-8. The embodiments herein may be implemented by computer software executable by the processor 910 of the device 900, or by hardware, or by a combination of software and hardware. The processor 910 may be configured to implement various embodiments of the present disclosure. Furthermore, a combination of the processor 910 and memory 920 may form processing means 950 adapted to implement various embodiments of the present disclosure.

The memory 920 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 920 is shown in the device 900, there may be several physically distinct memory modules in the device 900. The processor 910 may be of any type suitable to the local technical network, and may include one or more of general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 2-8. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

What is claimed is:

1. A method of communication, comprising:
determining, at a terminal device, a first priority value for a first channel state information (CSI) report at least in part based on an association relationship between the first CSI report and a set of capability parameters; and
transmitting, to a network device, the CSI report based on the determined priority value.

2. The method of claim 1, wherein determining the first priority value comprises:
determining the first priority value further based on at least one of the following:
a time-domain behavior of the first CSI report, the time-domain behavior being one of a periodic time domain behavior, an aperiodic time domain behavior, and a semi-persistent time domain behavior,
a cell index corresponding to the first CSI report,
a band identity corresponding to the first CSI report,
an identity of the first CSI report, or
a determination whether the first CSI report carries a signal quality measurement result.

3. The method of claim 1, wherein determining the first priority value comprises:
determining the first priority value based on a priority rule, the priority rule associated with at least one of the following:
at least one first parameter defined for a situation that the first CSI report is associated with a set of capability parameters, or
at least one second parameter defined for a situation that the first CSI report is not associated with a set of capability parameters.

4. The method of claim 1, wherein if the first CSI report is associated with a set of capability parameters, a first priority level of the first CSI report is higher than a second priority level of a second CSI report that is not associated with a set of capability parameters.

5. The method of claim 4, wherein the second CSI report carries a signal quality measurement result.

6. The method of claim 4, wherein the first CSI report is associated with a first cell index and the second CSI report is associated with a different second cell index.

7. The method of claim 6, wherein the first and second cell indexes are associated with a same frequency band.

8. The method of claim 4, wherein the first priority level is higher than the second priority level if the first CSI report and the second CSI report are configured with a same time-domain behavior.

9. The method of claim 4, wherein the first priority level is higher than the second priority level if the second CSI report is configured with a certain time-domain behavior.

10. The method of claim 4, wherein the first priority level is higher than the second priority level regardless of time-domain behaviors configured to the first and second CSI reports.

11. The method of claim 2, wherein determining the first priority value based on the time-domain behavior of the first CSI report comprises:
determining, based on the time-domain behavior of the first CSI report, the first priority value according to a priority order of one of the following:
an aperiodic time domain behavior, a semi-persistent time domain behavior and a periodic time domain behavior, or
a periodic time domain behavior, an aperiodic time domain behavior, and a semi-persistent time domain behavior.

12. The method of claim 1, wherein determining the first priority value comprises:
determining the first priority value to be a default priority value corresponding to a higher priority level.

13. The method of claim 12, wherein the default priority value is determined based on at least one of the following:
a minimum priority value, or
a time-domain behavior of the first CSI report.

14. The method of claim 1, wherein the set of capability parameters correspond to a panel deployed on the terminal device; and
the first CSI report comprises an identity information of one of the following:
an index of the set of capability parameters,
information about a panel type of the panel, or
an index of the panel.

15. The method of claim 14, wherein a bit size of the identity information is determined based on at least one of the following:
a first number of sets of capability-related parameters supported by the terminal device, or
a second number smaller than the first number, the second number being determined either by the terminal or the network device.

16. The method of claim 1, further comprising:
transmitting, to the network device, capability-related information of the terminal device, the capability-related information indicating at least one set of capability-related parameters, a set of capability parameters of the at least one set of capability parameters comprising at least one of the following:
identity information of the set of capability parameters,
a maximum number of sounding reference signal SRS ports,
a coherent type,
a maximum number of uplink layers,
a maximum number of downlink layers,
a maximum number of reference signal (RS) ports,
a maximum number of codewords, or
a maximum number of multiple input multiple output (MIMO) layers.

17. The method of claim 1, further comprising:
performing an initial transmission with the network device by using a default set of capability parameters.

18. The method of claim 1, further comprising:
transmitting, to the network device, a CSI report associated with a set of capability parameters during a random access (RA) procedure.

19. A method of communication, comprising:
generating, at a terminal device, a first and second channel state information (CSI) reports both of which are associated with a set of capability parameters; and
processing the first and second CSI reports by at least one of the following:
selecting a CSI report to carry identity information of a set of capability parameters from the first and second CSI reports;
dropping one of the first and second CSI reports; or
comprising a same identity information of a set of capability parameters in the first and second CSI reports.

20. A method of communication, comprising:
if a channel state information (CSI) report associated with a set of capability parameters is triggered, performing, at a terminal device, at least one of the following:
applying a minimum processing time requirement specific to a CSI report associated with a set of capability parameters; or
transmitting the CSI report regardless of at least of the following:
whether a timeline requirement is satisfied;
whether a processing time requirement is satisfied;
whether a timing advance is satisfied; or
whether a minimum processing time requirement is satisfied.

21. The method of claim 20, wherein the CSI report is aperiodic.

22. A method of communication, comprising:
receiving, at a terminal device and from a network device, a configuration indicating a repetition number for a channel state information (CSI) report associated with a set of capability parameters; and
in response to a CSI report associated with a set of capability parameters being triggered, transmitting, based on the repetition number, the CSI report to the network device.

23. A method of communication, comprising:
generating, at a terminal device, at least one channel state information (CSI) report; and
allocating a transmission power among the at least one CSI report based on at least one of the following:
an association relationship between a CSI report and a set of capability parameters, or
a time-domain behavior of a CSI report.

24. The method of claim 23, wherein allocating a transmission power based on the association relationship between a CSI report and a set of capability parameters comprises:
prioritizing the allocation transmission power to a CSI associated with a set of capability parameters.

25. A method of communication, comprising:
generating, at a network device, a configuration indicating a repetition number for a channel state information (CSI) report associated with a set of capability parameters; and
transmitting the configuration to a terminal device.

26. A terminal device comprising:
a processor; and
a memory coupled to the processor and storing instructions thereon, the instructions, when executed by the processor, causing the terminal to perform the method according to any of claims 1-24.

27. A network device comprising:
a processor; and
a memory coupled to the processor and storing instructions thereon, the instructions, when executed by the processor, causing the device to perform the method according to claim 25.

28. A computer readable medium having instructions stored thereon, the instructions, when executed on at least one processor, causing the at least one processor to perform the method according to any of claims 1-25.
